(19) United States
(12) Patent Application Publication
(10) Pub. No.: US 2013/0110586 A1
(43) Pub. Date: May 2, 2013

(54) DEVELOPING A CUSTOMIZED PRODUCT STRATEGY

(71) Applicant: Salesforce.com, inc., San Francisco, CA (US)

(72) Inventor: Simon Mulcahy, Corte Madera, CA (US)

(73) Assignee: SALESFORCE.COM, INC., San Francisco, CA (US)

(21) Appl. No.: 13/653,919

(22) Filed: Oct. 17, 2012

Related U.S. Application Data
(60) Provisional application No. 61/554,831, filed on Nov. 2, 2011.

(51) Int. Cl. G06Q 10/00

(52) U.S. Cl. 705/7.36

(57) ABSTRACT

In one embodiment, a computer-implemented method that includes one or more steps that are executable by a processor to establish a product strategy for a company is provided. The method includes performing a pain point analysis of processes of the company. The paint point analysis is performed from the perspective of one or more key personas associated with the company. The method further includes generating a product strategy that includes at least one software prototype based on the pain point analysis.

### CROSS-REFERENCE TO RELATED APPLICATION

This application claims the benefit of U.S. provisional patent application Ser. No. 61/554,831, filed Nov. 2, 2011, which is hereby incorporated by reference in its entirety.

### TECHNICAL FIELD

Embodiments of the subject matter described herein relate generally to methods and systems for developing a product strategy. More particularly, embodiments of the subject matter relate to methods and systems for developing a customized product strategy based on a pain point analysis.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

A plethora of already built and/or new applications may be available from the cloud to any customer. Determining which applications to make use of and how to make us of those applications can be a daunting task. Consulting firms have been established to aid in customers in determining their product strategy. A consulting firm typically generates a product strategy by evaluating the company based on problems perceived by the company. In some cases, this evaluation process may take many months.

Accordingly, it is desirable to provide methods and products for developing a product strategy from a different perspective. In addition, it is desirable to provide methods and products for a product strategy relatively fast. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary product strategy system in accordance with various embodiments.

FIG. 2 is a flow diagram illustrating an initiate stage of the product strategy system in accordance with various embodiments.

FIG. 3 is an illustration of a timeline of the product strategy system in accordance with various embodiments.

FIG. 4 is a flow diagram illustrating a map stage of the product strategy system in accordance with various embodiments.

FIG. 5 is a graph illustrating a pain point map of the product strategy system in accordance with various embodiments.

FIG. 6 is a flow diagram illustrating a redesign stage of the product strategy system in accordance with various embodiments.

FIG. 7 is a flow diagram illustrating a build stage of the product strategy system in accordance with various embodiments.

FIG. 8 is a flow diagram illustrating a present stage of the product strategy system in accordance with various embodiments.

### DETAILED DESCRIPTION

The following detailed description is merely exemplary in nature and is not intended to limit the disclosure the application and uses of the disclosure. Furthermore, there is no intention to be bound by any expressed or implied theory presented in the preceding technical field, background, brief summary or the following detailed description. It should be understood that throughout the drawings, corresponding reference numerals indicate like or corresponding parts and features.

The exemplary embodiments presented here relate to a product strategy development system and related techniques, methodologies, procedures, and technology for developing customized product strategies. The product strategy development system can be a product itself that can be used by consulting companies or other entities when developing product strategies for clients. As can be appreciated, the described subject matter can be implemented in the context of various environments. For exemplary purposes, the subject matter is described in the context of a computer-implemented environment relating to, for example, software products for a software-based system, a database system, a multi-tenant environment, or the like.

As used herein, an organizing entity is an entity that makes use of a product strategy development system disclosed herein to develop a product strategy for a requesting client or company (hereinafter referred to as company).

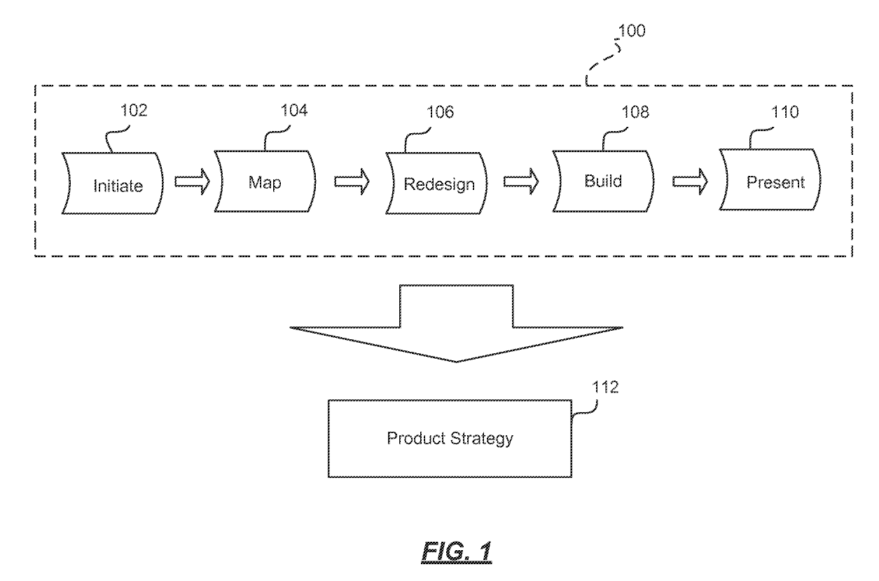

Turning now to FIG. 1, an exemplary product strategy development system 100 is shown to include multiple progressive stages. In various embodiments, the stages include, but are not limited to, an initiate stage 102, a map stage 104, a redesign stage 106, a build stage 108, and a present stage 110. The product strategy development system 100 produces a product strategy 112 upon execution of the stages 102-110. In various embodiments, the product strategy 112 includes one or more prototypes that demonstrate exemplary software or computer implemented products that may be part of the product strategy 112, and an execution plan for completing the software of computer implemented products and integrating the software or computer implemented products with a company's processes.

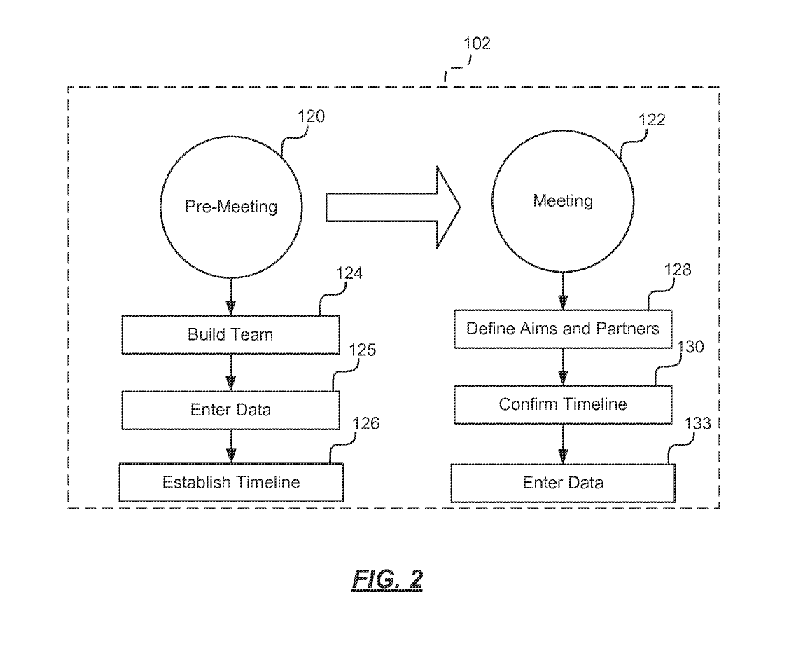

As will be discussed in more detail with regard to FIGS. 2-9, each stage 102-110 includes one or more phases. At each phase, one or more steps, tasks, or operations (commonly referred to below as steps) are performed by either the organizing entity, individuals associated with the company, an automated computer process, an individual interacting with a computer, and/or a combination thereof. In certain exemplary embodiments, at least one phase associated with the product strategy development system 100 involves, is executed by, or is implemented with a computing device, apparatus, or system that is programmed with software to perform specialized steps, tasks, or operations that support at least some of the described functionality.

The steps, tasks or operations are performed based on information provided by either the organizing entity, individuals associated with the company, a computer, and/or a combination thereof. As a result of performing the steps, tasks, or operations, various phases produce various deliverables. The deliverables are used in developing the product strategy 112. As will be discussed in more detail below, the stages 102-110 can be performed such that the product strategy 112 can be developed relatively fast. For example, using the product strategy development system 100, the product strategy 112 may be developed in eight weeks or less.

In various embodiments, each stage 102-110 may be implemented as a module of a product strategy development product. The modules 102-110 include at least one processor and some form of memory that execute one or more of the operations, tasks, or steps.

Referring now to FIG. 2, the initiation stage 102 is described in more detail with regard to a flow diagram. The initiation stage 102 begins once a company has requested that a product strategy 112 be developed for their company. The initiation stage includes, but is not limited to, a pre-meeting phase 120, and a meeting phase 122. At the pre-meeting phase 120, information is gathered by the organizing entity about the particular company and a team of individuals from the organizing entity is established to assist with the development of the product strategy 112 at 124. After building the team at 124, data associated with the information or the team members may be entered into any desired file format and saved for future processing and reference at 125.

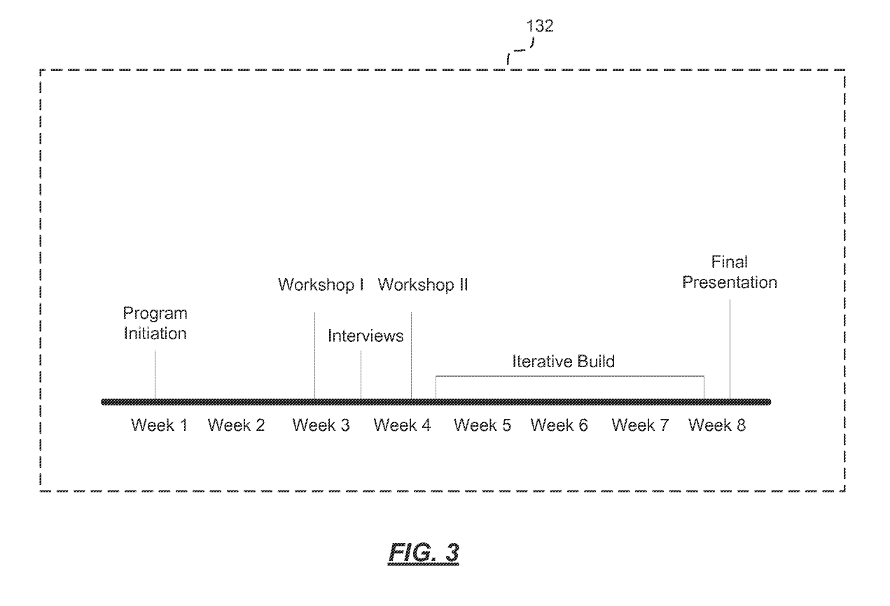

A timeline is established for producing the product strategy 112 at 126. As shown in FIG. 3, an example timeline 132 includes tentative dates for milestones such as meetings, workshops, build time, and deliverables of the stages 102-110. In particular, the example timeline includes dates for two workshops, interviews, a build schedule, and a final presentation. As can be appreciated, milestones other than described can be added to the timeline and/or the described milestones can be removed from the timeline in various embodiments. The product strategy 112 is delivered to the company at the final presentation. As shown, the time to produce the product strategy 112 is within eight weeks. As can be appreciated, the dates for any of the meetings, workshops, build time, and deliverables can be adjusted to further reduce the time to produce the product strategy 112.

With reference back to FIG. 2, at the meeting phase 122, a meeting either by phone or in person is conducted with individuals of the company. During the meeting overall aims of the product strategy are defined and potential partners for the product strategy are defined at 128. Further at the meeting, the timeline 132 is confirmed with the company at 130. After the meeting, data associated with the overall aims and potential partners may be entered into any desired file format and saved for future processing and reference at 133.

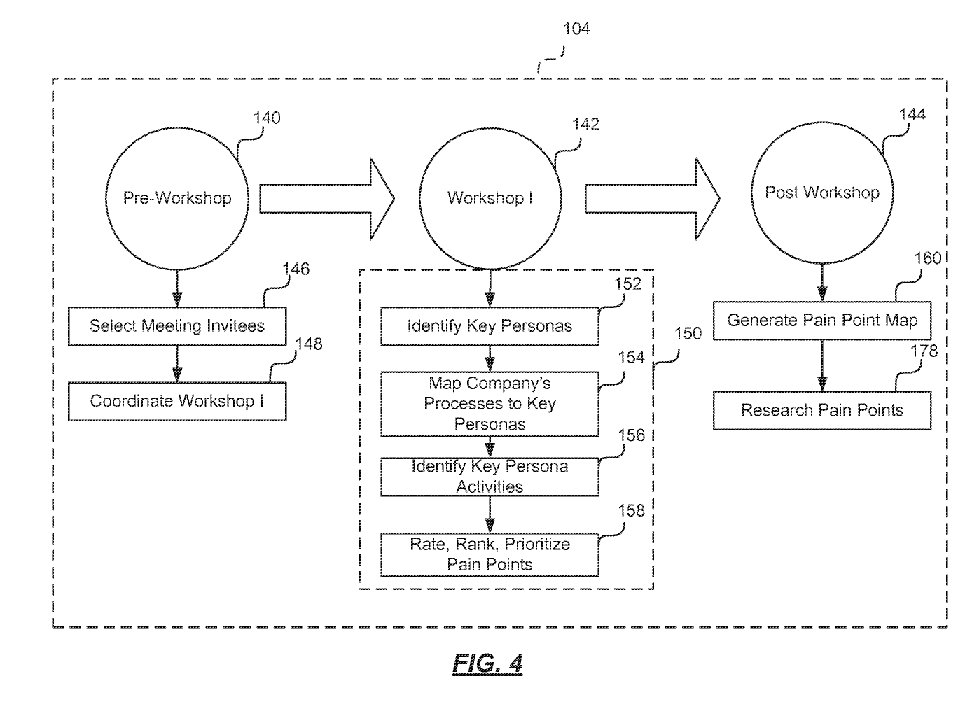

Referring now to FIG. 4, the map stage 104 is described in more detail with regard to a flow diagram. The map stage 104 begins once the initiation stage 102 (FIG. 1) is complete. The map stage 104 includes, but is not limited to, a pre-workshop phase 140, a workshop I phase 142, and a post workshop phase 144. At the pre-workshop phase 140, based on the information that was gathered in the initiation stage 102 (FIG. 1), a first workshop is planned according to the timeline 132 (FIG. 3). For example, meeting invitees are selected based on an invitee's role or association with the company at 146. The first workshop is then coordinated by setting the date and time according to the timeline 132 (FIG. 3) and by inviting the invitees at 148.

At the workshop I phase 142, the first workshop is conducted. Typically the first workshop lasts a half day or a day and involves the invitees as well as members of the team from the organizing entity. During the first workshop a pain point analysis is performed at 150. The pain point analysis 150 evaluates the company's processes from the perspective of various personas. The paint point analysis 150 includes multiple steps that are performed by the invitees alone or with the help of the team members from the organizing entity.

In various embodiments, the steps associated with the pain point analysis include, but are not limited to, an identify personas step 152, a map step 154, an identify key persona activities step 156, and a prioritize step 158. The identify personas step 152 is typically performed first. Although a particular order of the steps is described herein, it can be appreciated that the steps may be performed in various other orders and still perform a paint point analysis.

The identify personas step 152 identifies key types of individuals that may interact with the company's various processes. The personas may include customers, clients, employees, venders, suppliers, or any other individual that interacts with or is associated with the company. For example, when a company's processes relate to travel and trip planning, the key personas of the company may include a frequent traveler, an occasional traveler, an approver of the trip, a planner or assistant, and a chief financial officer or a travel manager, or any other individual or entity that may play a role in establishing a trip plan.

Once the key personas are identified, the map step 154 is performed. The map step 154 maps the key personas to processes of the company. For example, when the company's processes relate to travel and trip planning, the frequent traveler may be associated with a trip planning process, the approver may be associated with a budget management process, and the planner may be associated with a trip notification process. As can be appreciated, each persona may interact with multiple processes of the company.

Once the mapping is complete, the identify key persona activities step 156 is performed. The identify key persona activities step 156 identifies key persona activities in the processes from the perspective of the key personas. For example, keeping the example in the context of the travel company, a pain point of the frequent traveler may be dealing with little details of planning that add up to major time sinks. A key persona activity of the approver may be managing the budget for each trip. A key persona activity for the planner may be providing real-time updates to travelers. As can be appreciated, each persona may interact with multiple processes and may have multiple key persona activities for each process.

Once the key persona activities are identified for each key persona, the prioritize step 158 is performed. The prioritize step 158 rates, ranks, and prioritizes the key persona activities to determine which of those are pain points. The rating, ranking, and prioritization can be performed based on criteria established at the onset in phase 140. There are generally three criteria covering both human experience and commercial value. For example, continuing with the travel example, the key activities for each persona (travelers, planner and approver) would be rated first for burden (the amount of effort required for each activity), second for dissatisfaction (the degree of unhappiness with the existing experience in carrying out that activity), and third for business ROI (what the perceived return to the business would be if this key activity was significantly improved). This activity yields scores for each criterion for each key activity, providing the ability to rank individual key persona activities according to pain. Thus, the pain points are identified via the ranking and prioritizing. Once the prioritize step 158 is complete, the key persona activity analysis may be complete 150 and the first workshop may be concluded.

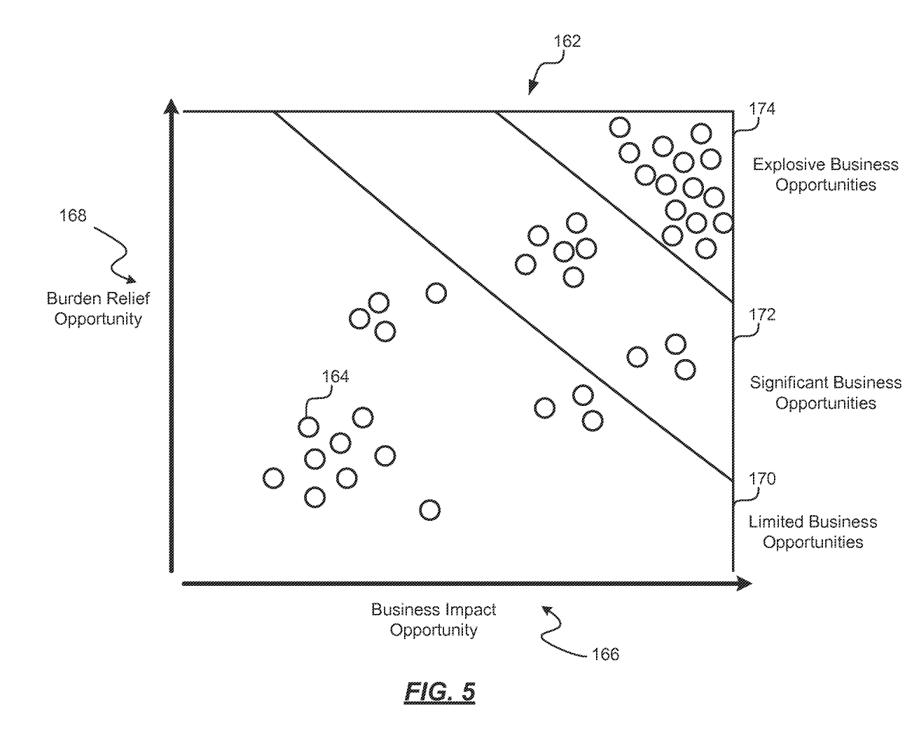

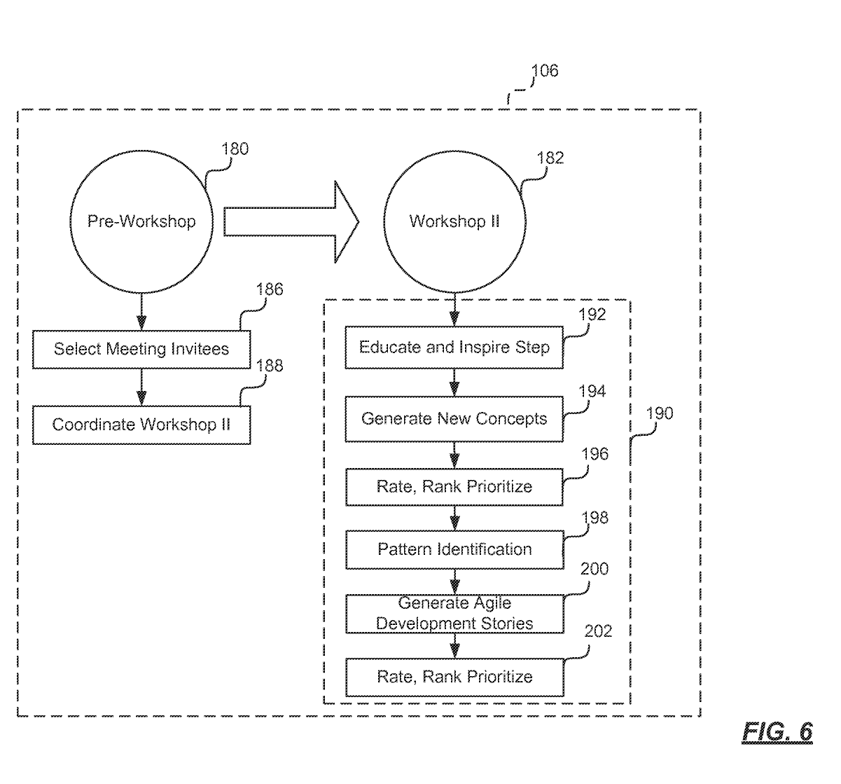

At the post workshop phase 144, a pain point map is generated, for example, based on data entered by a team member from the organizing entity resulting from the pain point analysis 150 at 160. For example, as shown in FIG. 5, a map 162 of pain points 164 is generated based on a business impact opportunity of the pain point 168 (shown along the x-axis at 166) and a burden relief opportunity of the paint point 168 (shown along the y-axis at 168). The map 162 categorizes the mapped pain points 168 in various predefined categories based on their burden relief opportunity and their business impact opportunity. The various categories include, but are not limited to, a limited business opportunity 170, a significant business opportunity 172, and an explosive business opportunity 174. Detailed research is then carried out on the explosive and significant pain points at 178 to uncover examples of creative approaches to similar challenges in contexts outside of the confines of the current industry. This research includes how the organizing entity itself may have solved for analogous pain points, or how others in significantly different sectors, including non-business sectors have solved for this. These examples are captured and categorized for use in a subsequent workshop (i.e. workshop II 182 FIG. 6).

Referring now to FIG. 6, the redesign stage 106 is described in more detail with regard to a flow diagram. The redesign stage 106 begins once the map stage 104 (FIG. 1) is complete. The redesign stage 106 includes, but is not limited to, a pre-workshop phase 180, and a workshop II phase 182. At the pre-workshop phase 180, a second workshop is planned according to the timeline 132 (FIG. 3). For example, meeting invitees are selected based on an invitee's role or association with the company at 186. The invitees may include the same invitees as the first workshop and/or may include different invitees from the first workshop. The second workshop is then coordinated by setting the date and time according to the timeline 132 (FIG. 3) and by inviting the invitees at 188.

At the workshop phase 182, the second workshop is conducted. Typically the second workshop lasts a half day or a day and involves the invitees as well as team members from the organizing entity. During the second workshop story redesign 190 is performed. The story redesign 190 includes rewriting key elements of stories associated with the pain points to achieve a best possible solution. The story redesign 190 includes multiple steps that are performed by the invitees alone or with the help of the organizing entity.

In various embodiments, the steps include, but are not limited to, an educate and inspire step 192, a determine storyboard step 194, generate new concepts step 194, a rate, rank and prioritize step 196, a pattern identification step 198, a generate agile development stories step 200, and a rate, rank and prioritize agile development stories step 202. The educate and inspire step 192 is typically performed first. Although a particular order of the steps is described herein, it can be appreciated that the steps may be performed in various other orders and still achieve a rewrite of the stories.

The determine educate and inspire step 192 involves both the organizing entity and the invitees with the aim of exposing all to a series of inspirations that challenge industry assumptions and offer multiple, alternative ways of solving for pain points approximately analogous to those generated in step 150.

The generate new concepts step 194 takes place in parallel to, or following the educate and inspire step 192. The generate new concepts step 194, generates or captures large numbers of new concepts. Using the travel example of earlier, new concepts may be generated to solve for, for example, the need to inspire business travelers to book cheaper travel. These concepts may be inspired from tangential thinking and best practices in the investment industry. Once a new mental model is created in this way, new concepts are arrived at quickly.

Once enough concepts have been captured, the rate, rank and prioritize step 196 is performed. The rate, rank and prioritize step 196 scores all concepts captured in the generate new concepts step 194. Scoring may be carried out in multiple ways according to the yield of concepts in step 194. The result of the scoring is a list of ranked concepts. Prioritization is then carried out to reduce the overall number of concepts to a manageable number.

Once the prioritized list of concepts is determined, the pattern identification step 198 may be performed, if needed. This step involves invitees grouping the prioritized concepts into a small number of concept clusters. The pattern identification step 198 generally involves identification of larger opportunities that are generated when multiple, similar concepts are brought together. Using our travel example, concepts such as a real-time trip budgeting, situational notifications, socially derived actionable insights and recommendations may be clustered into a new concept of a digital trip concierge.

Once the prioritized concepts/clusters have been determined, the generate agile development stories step 200 is performed. The generate agile development stories step 200 converts the concept to agile development stories. Agile development stories are short, clearly articulated statements of functionality. They generally adhere to a specific language for example, “As a [persona], I need to . . . . So that I can . . . ”. For example, again using the travel example, “As an infrequent traveler, I need to press one button to be connected directly to an agent in order to solve in-trip problems”, or “As an approver, I need to visually see where the greatest business opportunities are geographically in order to be able to determine which trips to prioritize”.

Once the generate agile development stories 200 step is complete, the agile development stories are rated, ranked and prioritized in step 202. Similar in concept to step 196, each agile development story is rated, then ranked. This provides a priority list of agile development stories.

Once the agile development stories are rated, ranked and prioritized, story redesign 190 may be complete and the second workshop may be concluded.

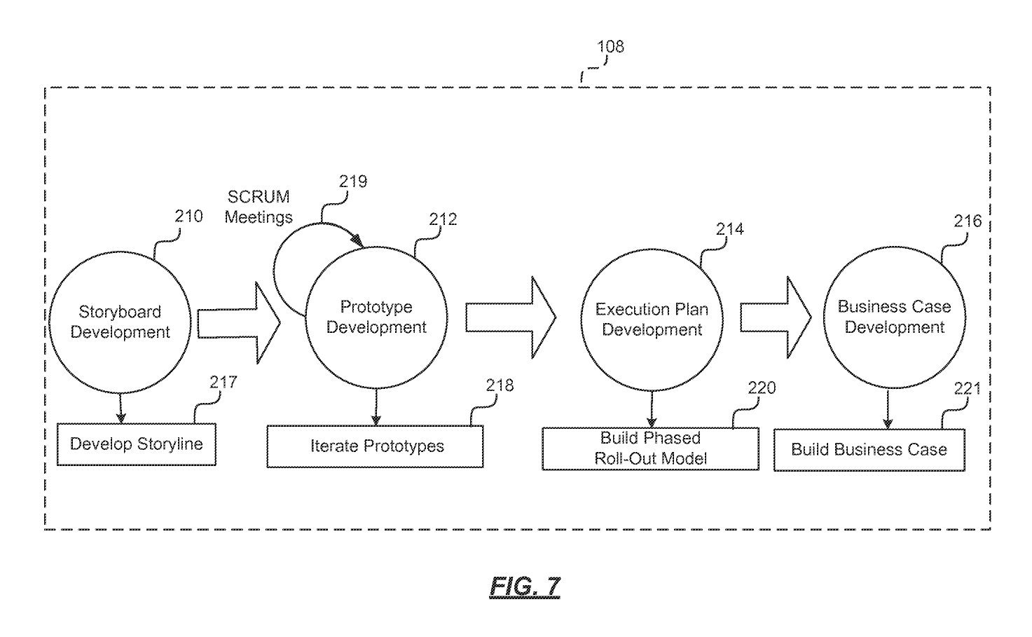

Referring now to FIG. 7, the build stage 108 is described in more detail with regard to a flow diagram. The build stage 108 begins once the redesign stage 106 (FIG. 1) is complete. The build stage 108 includes, but is not limited to, a storyboard development phase 210, a prototype development phase 212, and an execution plan development phase 214, and a business case development phase 216. At the storyboard development phase 210, the agile development stories are molded into a single storyline at 217. For example, an analysis of the substantial notes that are also captured in both workshops is performed. The result is a narrative (storyboard) that verbally describes the newly conceived concepts in the form of a scenario. This narrative concurrently detailed specific product functionality required to facilitate/enable the new scenario.

Using the travel example from earlier, the narrative might be written as follows: “Mary on laptop—clicks on Trip Library and goes to auto-generated search, prepopulating search box based on previous trip criteria/trip preferences (this is not a full itinerary, but a fast way of getting to one (saved search type thing). She creates a ‘Seattle May 2012 trip group’ and adds co-travelers. Mary shares her itinerary with them.” This narrative describes to-be-built functionality in some degree of accuracy: “By turning on Opportunity view, Nathan can view contacts and opportunities by relevance score/trip value points in 4 ways: 1. Accounts/Records I Own; 2. Accounts/Records I Follow; 3. Accounts/Records with many related records (including Chatter Posts); 4. Accounts that contain Opportunities I'm working on.

At the prototype development phase 212, prototypes of products that aid in achieving the best possible solution according to the storyboard are developed. For example, prototypes of software products that aid in achieving the best solution may be developed. As can be appreciated, prototypes of other types of products can be developed and thus the disclosure is not limited to the present example.

In various embodiments, the software prototypes may be developed according to agile software development methods that are based on iterative and incremental development at 218. For example, the prototypes may be iteratively developed using Scrum methods. The Scrum methods can include a Scrum meeting 219 that occurs, for example, daily or at some other scheduled times to incorporate feedback into the iterative development of the prototypes. As can be appreciated, other agile software development methods can be used to develop the prototypes and thus the disclosure is not limited to the present example.

At the execution plan development phase 214, an execution plan for rolling out the products is developed. For example, the execution plan is developed at 220 that includes a phased roll-out model that illustrates how to operationalize the story of the storyboard.

Concurrent with the execution plan development phase 214, the business case development phase 216 may be performed. At the business case development phase 216, a business case is built at 221. For example, the business case includes a detailed breakdown of how the overall plan impacts key business metric identified in phase 102. This breakdown almost always includes how the plan (i) makes money; (ii) saves money; and (iii) positively impacts either customer or employee satisfaction metrics.

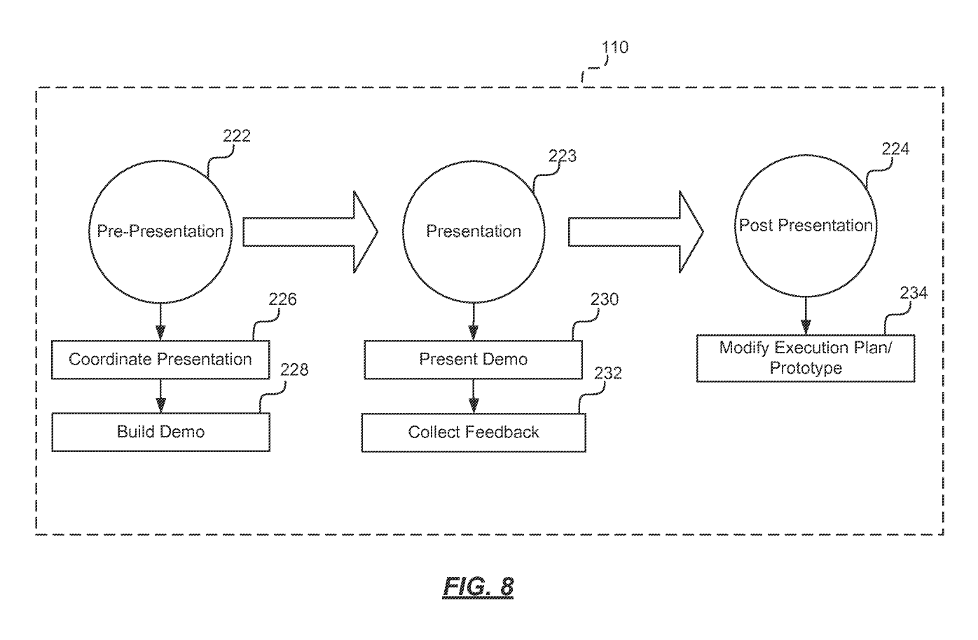

Referring now to FIG. 8, the present stage 110 is described in more detail with regard to a flow diagram. The present stage 110 begins once the build stage 108 (FIG. 1) is complete. The present stage 110 includes, but is not limited to, a pre-presentation phase 222, a presentation phase 223, and a post presentation phase 224. At the pre-presentation phase 222, a presentation is planned according to the timeline at 226. For example, invitees are selected based on the invitee's role or association with the company. The presentation is then coordinated by setting the date and time according to the timeline and by inviting the invitees. Further at the presentation phase 222, a demo is built based on the developed prototypes and stories from the storyboards at 228. In various embodiments, the demo includes web-based user-interfaces, web-pages, as well as iPad and iPhone applications. These use the prototypes developed at 218, within the context of the storyboard developed at 217.

At the presentation phase 223, the presentation is performed. For example, the storyboard and demo are presented to the invitees from the company at 230 and any feedback from the company is collected and entered as data in any file format for further processing and reference at 232. At the post presentation phase 224, the plan and/or prototypes may be modified. For example, the execution plan and/or the prototypes may be modified based on any feedback provided at the presentation at 234.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method that includes one or more steps that are executable by a processor to establish a product strategy for a company, the method comprising:
performing a pain point analysis of processes of the company, wherein the paint point analysis is performed from the perspective of one or more key personas associated with the company; and
generating a product strategy that includes at least one computer implemented prototype based on the pain point analysis.

2. The method of claim 1, wherein the pain point analysis comprises identifying the one or more key personas associated with the company.

3. The method of claim 1, wherein the pain point analysis comprises mapping the one or more key personas of the company to one or more processes of the company.

4. The method of claim 1, wherein the pain point analysis comprises identifying at least one pain point of a process from the perspective of the one or more key personas.

5. The method of claim 4, wherein the pain point analysis further comprises at least one of rating, ranking, and prioritizing the at least one pain point.

6. The method of claim 1, further comprising redesigning stories depicting scenario of the company based on the pain point analysis.

7. The method of claim 6, wherein the redesigning stories comprises converting at least one pain point into a story that depicts a scenario that occurs that produces the at least one pain point for the key persona.

8. The method of claim 7, wherein the redesigning stories comprises generating at least one new concept for the story.

9. The method of claim 8, wherein the redesigning stories comprises at least one of rating, ranking, and prioritizing the at least one new concept.

10. The method of claim 6, wherein the redesigning stories comprises developing at least one agile development story based on a story that depicts a scenario that occurs that produces at least one pain point for the one or more key personas.

11. The method of claim 10, wherein the redesigning stories comprises at least one of rating, ranking, and prioritizing the at least one agile development story.

12. The method of claim 1, further comprising generating at least one computer implemented prototype based on the pain point analysis.

13. The method of claim 11, wherein the generating the at least one computer implemented prototype is based on an agile software development method.

14. The method of claim 11, further comprising building an execution plan based on the at least one computer implemented prototype.

15. The method of claim 13, wherein the execution plan is according to a phased roll-out model.

16. A system for generating a computer implemented product strategy for a company, the system comprising:
a map module that performs a pain point analysis of processes of the company, wherein the paint point analysis is performed from the perspective of one or more key personas associated with the company; and
a build module that builds at least one computer implemented prototype based on the pain point analysis.

17. The system of claim 15, wherein the pain point analysis identifies the one or more key personas associated with the company.

18. The system of claim 15, wherein the pain point analysis maps the one or more key personas of the company to one or more processes of the company.

19. The system of claim 15, wherein the pain point analysis identifies at least one pain point of a process from the perspective of the one or more key personas.

20. The system of claim 18, wherein the pain point analysis at least one of rates, ranks, and prioritizes the at least one pain point.

21. The system of claim 15, further comprising a redesign module that redesigns a story that depicts a scenario of the company based on the pain point analysis.

22. The system of claim 21, further comprising a redesign module that generates at least one new concept for the story.

23. The system of claim 22, wherein the redesign module at least one of rates, ranks, and prioritizes the at least one new concept.

24. The system of claim 21, wherein the redesign module develops at least one agile development story based on a story that depicts a scenario that occurs that produces at least one pain point for the one or more key personas.

25. The system of claim 24, wherein the redesign module at least one of rates, ranks, and prioritizes the at least one agile development story.

26. The system of claim 15, wherein the build module generates the at least one computer implemented prototype based on an agile software development method.

27. The system of claim 26, wherein the build module includes an execution development phase that builds an execution plan based on the at least one software prototype.

28. The system of claim 27, wherein the execution plan is according to a phased roll-out model.

29. A business method for generating a computer implemented product strategy, comprising:
performing a pain point analysis of processes of the company, wherein the paint point analysis is performed from the perspective of one or more key personas associated with the company;
performing a story redesign of stories that depict scenarios of the company based on the pain point analysis; and
building at least one computer implemented prototype based on the story redesign; and
generating a product strategy that includes the at least one computer implemented prototype.
